(19) United States
(12) Patent Application Publication
(10) Pub. No.: US 2006/0010886 A1
(43) Pub. Date: Jan. 19, 2006

(54) Liquid cryogen dosing system with nozzle for pressurizing and inerting containers

(76) Inventor: Eric D. Clamage, Stamford, CT (US)

Correspondence Address: KRAFT / FETF, 120 S. LASALLE STREET, SUITE 1600, CHICAGO, IL, 60603-3406, US

(21) Appl. No.: 10/890,372

(22) Filed: Jul. 14, 2004

(51) Int. Cl. F17C 7/02; F25D 17/02

(52) U.S. Cl. 62/64; 62/50.1; 62/52.1

(57) ABSTRACT

A liquid cryogen dispensing system employing a splash-reducing nozzle for substantially reliable and uniform dispensing of liquid cryogen into a container for a beverage, food product, or other product, such as a still (non-carbonated) hot-filled container. The dispensing system has a nozzle which includes an orifice plate having an array of apertures to dispense a dose of liquid cryogen into an underlying container as a generally ring-shaped “shower” of discrete liquid cryogen streams, which can be gently impacted upon the surface of the contents of the container to minimize splashing, and help ensure satisfactory pressurization or inerting of the container.

### FIELD OF THE INVENTION

The invention relates generally to liquid cryogen dispensing systems, and more particularly to systems for dispensing liquid cryogens into containers for beverages, food or other products.

### BACKGROUND OF THE INVENTION

Numerous packages contain carbonated beverages under pressure. Some containers, notably two-piece aluminum cans, are designed with a thin side walls to reduce weight and material costs. These containers, as well as other thin-walled containers such as plastic bottles and the like, rely significantly upon the internal pressure of the carbonated product within the container to prevent container walls from buckling or collapsing inward when subjected to external stresses associated with shipping, handling and display.

Non-carbonated drinks, such as bottled or canned fruit drinks, teas, and the like, have become increasingly popular. These non-carbonated drinks are often packaged in similar containers as the carbonated beverages. In the absence of internal pressure due to carbonation, such containers may be more susceptible to buckling.

It is known to physically mix gaseous nitrogen into such still products prior to packaging thereof, in order to provide nitrogen gas for pressurization of the container. However, nitrogen gas does not mix easily with these products. Introduction of liquid nitrogen into containers prior to sealing can pose problems relating to splashing of the liquid as it is being dispensed. See, e.g., U.S. Pat. No. 6,519,919.

There is a need for a commercially viable method of using liquid cryogen for pressurization of still beverages or other food and beverage products in thin-wall containers and other packaging, wherein splashing of the liquid cryogen is not unduly problematic.

### SUMMARY OF THE INVENTION

The invention provides a liquid cryogen dispensing system having a splash-reducing nozzle for substantially reliable and uniform dispensing of liquid cryogen into a container for a beverage, food product or other product, such as a still (non-carbonated) hot-filled beverage, just before it is sealed.

In one embodiment, a liquid cryogen delivery system including a dosing head is provided for introducing a dose of liquid cryogen into a product in a packaging assembly line. The dosing head includes a control valve and a unique liquid cryogen-dispensing nozzle. The control valve is operable to receive a flow of liquid cryogen from a liquid cryogen supply reservoir and controllably output metered doses of liquid cryogen to a dispensing nozzle in fluid communication therewith. The unique liquid cryogen-dispensing nozzle, which is in fluid communication with the control valve, is adapted to dispense liquid cryogen simultaneously as a plurality of liquid streams. The nozzle has an orifice plate and a nozzle body having a passageway which fluidly communicates with the orifice plate. The orifice plate preferably has a plurality of apertures through which streams of liquid cryogen are simultaneously dispensed from the nozzle into an open container.

In a preferred embodiment, the configuration of apertures provided in the nozzle orifice plate is arranged to dispense a dose of liquid cryogen into an underlying container as a generally ring-shaped “shower” of discrete liquid cryogen streams, which gently impact upon the surface of the fluid contents to minimize splashing. In this manner, containers may be more reliably pressurized as possible loss of cryogen from splashing is reduced, and freeze-ups on the liquid cryogen dispenser due to splashing cryogen may be avoided or significantly reduced. The reliably pressurized containers provided using a liquid cryogen dosing system in accordance with the invention are less apt to misshape during capping, sealing, and or handling.

In one embodiment, the orifice plate is disc shaped, and the apertures are arranged in a substantially circular pattern in the orifice plate to provide the “shower” pattern. In a preferred embodiment, apertures are provided in the outer radial regions of the orifice plate, and not at or near the central part thereof, in order to help isolate and dissipate the impacts of the individual streams upon the liquid surface of the container contents.

The dosing system and dispensing nozzle thereof in accordance with this invention are generally applicable to dispensing a liquefied cryogen gas which is useful for pressurizing or inerting containers, and to dispensing liquid nitrogen in particular.

The invention also relates to methods for pressurizing or inerting a hot filled product using the aforementioned dosing head. One of the methods of the invention comprises the steps of providing a open container hot filled with fluid contents; moving the hot-filled container beneath the aforementioned dosing head; and dispensing liquid cryogen from the nozzle into the container as a plurality of gentle liquid streams which softly impact the surface of the fluid contents, and thereby reduce or avoid splashing of the cryogen and or other fluid contents of the container. This method may be especially useful for dosing hot filled containers in a high speed automated moving production packaging assembly line, just before sealing. The dosing head with the unique nozzle as described herein permits substantially uniform doses of liquid cryogen to be reliably deposited into containers in a high speed packaging production line.

### BRIEF DESCRIPTION OF THE DRAWINGS

FIG. 1 is a schematic diagram of a liquid cryogen delivery system including a liquid cryogen dosing head in accordance with an embodiment of the invention.

FIG. 2 is another schematic diagram of the liquid cryogen delivery system including a liquid cryogen-dispensing nozzle of FIG. 1.

FIG. 3 is an enlarged schematic diagram of the dosing head and dosing arm of the liquid cryogen delivery system shown in FIG. 1.

FIG. 4 is a partial cutaway diagram of a dosing head with a liquid cryogen-dispensing nozzle useful in the liquid cryogen delivery system of FIG. 1.

FIG. 5 is an exploded perspective view of the nozzle body of the nozzle of the dosing head of FIG. 4.

FIG. 6 is a side view of the nozzle body of FIG. 5.

FIG. 7 is a top view of the nozzle body of FIG. 5.

FIG. 8 is a sectional view along section B-B of the nozzle body shown in FIG. 7.

FIG. 9 is a perspective view of an orifice plate used with the nozzle body of FIG. 3.

FIG. 10 is an edge view of an orifice plate of FIG. 9.

FIG. 11 is a bottom view of a nozzle tip including an orifice plate in a liquefied gas spray injection apparatus according to an embodiment of the invention.

FIG. 12 is an enlarged partial section view a container being dosed with the liquid cryogen dosing head and nozzle of FIG. 4.

The figures are not necessarily drawn to scale. Similarly numbered elements in different figures represent like features unless indicated otherwise.

### DETAILED DESCRIPTION OF THE PREFERRED EMBODIMENTS

The invention provides an improved nozzle configuration for a liquid nitrogen delivery system which reduces or even eliminates splashing and associated problems in pressurization or inerting operations performed on fluid filled containers in general and hot-filled beverage or foodstuff containers in particular.

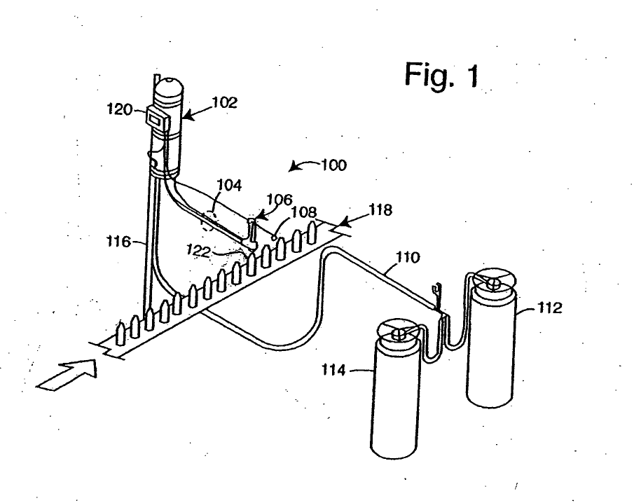

Referring to FIG. 1, a liquid nitrogen delivery system 100 is illustrated which includes a unique and improved liquid nitrogen dosing head 106 in accordance with an embodiment of the invention. The system 100 comprises a vacuum-insulated liquid nitrogen reservoir 102 that connects through a flexible conduit 104 to dosing head 106. The dosing head may be further supported using a bracket or other support (not shown). A sensor 108 is used to detect when the dosing head 106 should discharge liquid nitrogen into typical container 122 among a plurality of containers in an assembly line 118. A supply conduit 110 connects to standard liquid gas cylinders 112 and 114 filled with liquid nitrogen (“LN2”). A post 116 supports the reservoir 102 with an attachment that allows some up and down height adjustment. A typical bottle or can assembly line 118 passes at a high speed just under the dosing head 106. The assembly line 118 also may have a carousel configuration for progressively moving bottles beneath and away from dosing head 106. A control unit 120 uses the sensor 108 to determine when it should operate a control valve (not shown) in the dosing head 106 and the amount of time said control valve should be open.

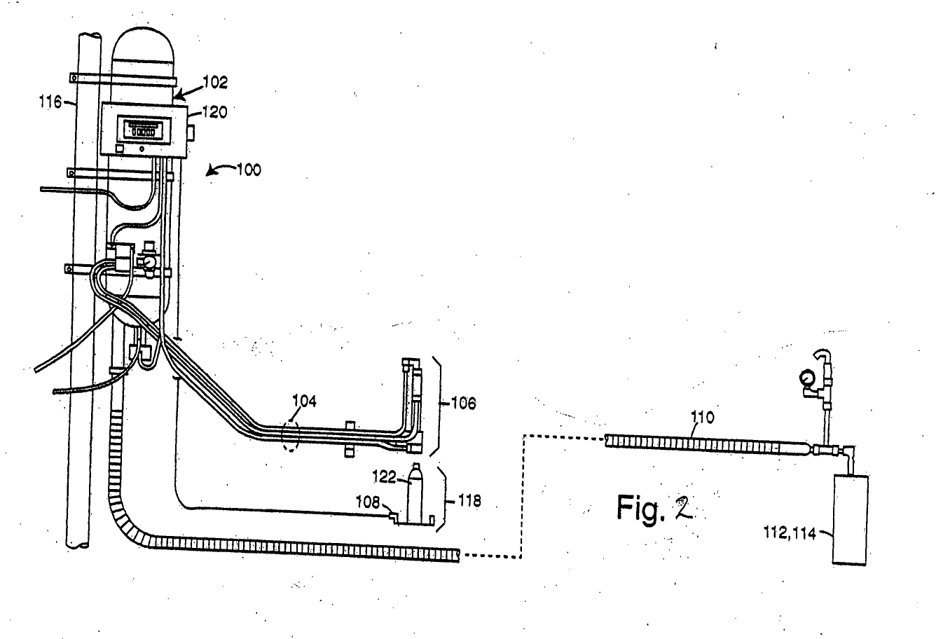

In one embodiment, container 122 is a bottle prefilled with a hot beverage or other flowable foodstuff before it is moved below dosing head 106. As seen in more detail in FIG. 2, container 122 is shown immediately before it receives its sealing cap at a capping station (not shown) that will contain the expanding gas resulting from the liquid nitrogen introduced by dosing head 106. The liquid nitrogen delivered into the bottle creates a gas pressure within the beverage or food container that increases package crushing pressure and wall strength. It also may inert the space between the product and the sealing cap to the container.

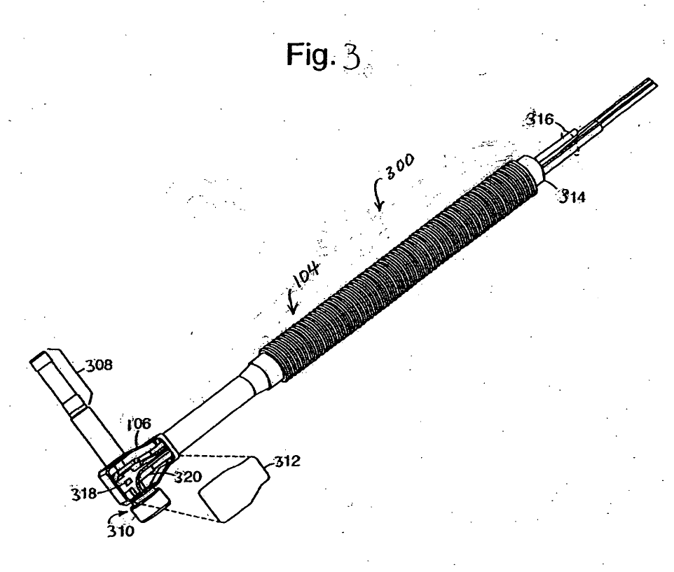

Referring to FIG. 3, flexible conduit 104 forms part of a dosing arm 300, and one end 314 of which is coupled into the vacuum-insulation envelope system of the vacuum-insulated liquid nitrogen reservoir 102. A group of feed, return, purge, and pressure tap conduits 316 also connect into the reservoir system 102. An actuator 308 operates a dosing valve within the dosing head 106. Nozzle area 310 is provided with an internal integral nitrogen gas purge and an electric heater to help prevent freeze-up. A cover 312 is welded or otherwise secured onto the side of the dosing head and completes the vacuum seal. An optional resistive-type electric heater 718 is attached to the side of the valve body 320. The heater, for example, may provide about fourty watts of heat from a 24-volt DC source. Such a heater 318 is operated only during servicing procedures. Standard vacuum insulating covering generally may be provided on the dosing arm 300.

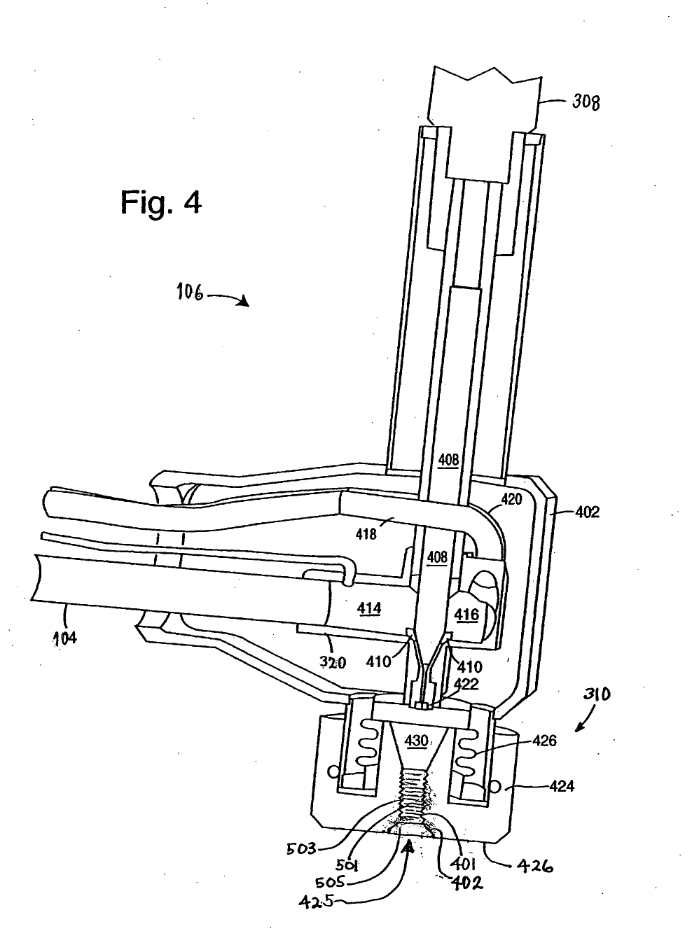

Referring to FIG. 4, dosing head 106 is shown with a dosing head body 402 which contains a vacuum for insulation and receives feed conduit 104 from one side. A vacuum-insulating jacket for the conduit 304 is not shown in this view. Valve body 320 receives a needle valve 408 that operates up and down against a valve seat 410. The actuator 308 located near the top of the dosing head 106 and operates the normally closed needle valve 408. The actuator 308 may be, for example, a pneumatic or an electric type. Metering orifice 422 is screwed into the valve body 320 down past the needle valve 408 and seat 410. This position permits the metering orifice 422 to be serviced from an opening inside a heated nozzle collar 424 and without having to drain the system first. The nozzle collar 424 is attached to the dosing head body 402, such as, for example, by welding. A metal bellows 426 provides a long thermal path that helps separate any heat in the nozzle collar 424 from the liquid nitrogen inside the valve body 320.

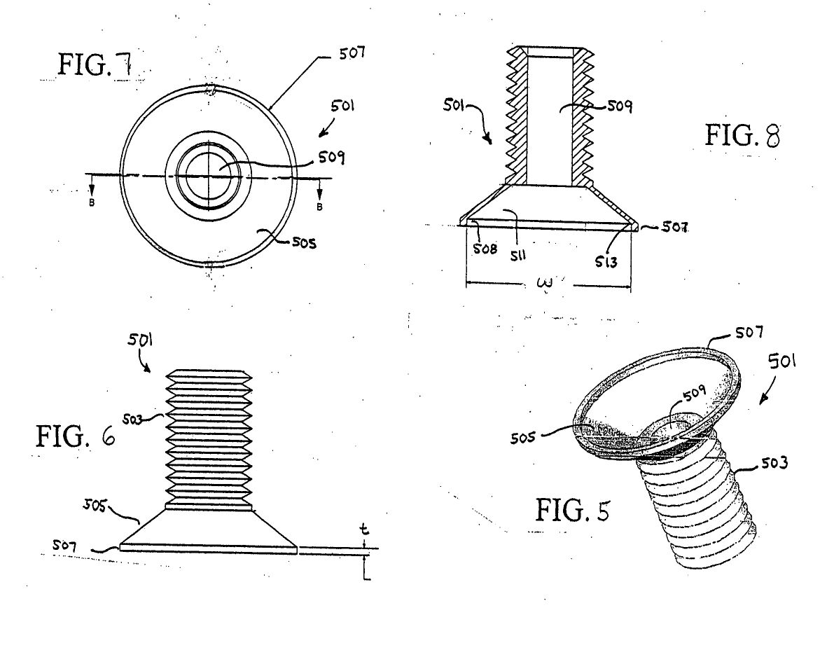

A nozzle 425 provides a passageway for discharging liquid nitrogen under pressure from the dosing head 106, such as when needle valve 408 is operated. The nozzle 425 includes a nozzle body 501 having an externally threaded stem 503 which defines an internal passageway that opens into a skirt 505 at its lower end. These and other nozzle features will be described in greater detail with reference to FIGS. 5-10 discussed infra. Referring to FIG. 4, the nozzle body 501 is detachably mounted within nozzle collar 424 via an integral internally-threaded bore 401 provided within nozzle collar 424 into which the stem portion 503 of the nozzle 425 may be fittingly screwed in and out. A mouth portion 402 also is provided in nozzle collar 424 at the entrance of the threaded bore 401, which has a shape which may conformably receive the skirt 505 of the nozzle body 501. In a preferred embodiment, the nozzle 425 may mounted within threaded collar bore 401 and mouth 402 in nozzle collar 424 in a manner such that the lower end of the nozzle 425 is substantially flush with the bottom 426 of the nozzle collar 424.

Referring still to FIG. 4, fed conduit 104 supplies a constant circulating flow of phase-separated liquid nitrogen to dosing head 106. During operation, supply chamber 414 is flooded with liquid nitrogen, which inundates the seating area of the needle valve 408. Any unused liquid nitrogen, or nitrogen that has turned to gas, is circulated past into a return chamber 416 and out back up to the reservoir through a dual pair of return lines 418 and 420 are routed back to the liquid nitrogen reservoir 102. The conduits, lines and jackets preferably should be flexible so that the position and tilt of dosing head 106 may be adjusted in the field without changing the position or attitude of the liquid nitrogen reservoir.

A purge chamber 430 is kept filled with gaseous liquid nitrogen to prevent a build-up of ice crystals that potentially could clog the nozzle 425 and or the metering orifice 422. A separate purge gas line (not shown) fed through a feed conduit (not shown) may be used to feed gaseous nitrogen to help keep nozzle 425 and also area 430 free of ice crystals, which, for example, may arise from frozen water vapor in the ambient air. For example, a purge gas flow rate of three to five standard cubic feet per hour (SCFH) may suffice for this purpose.

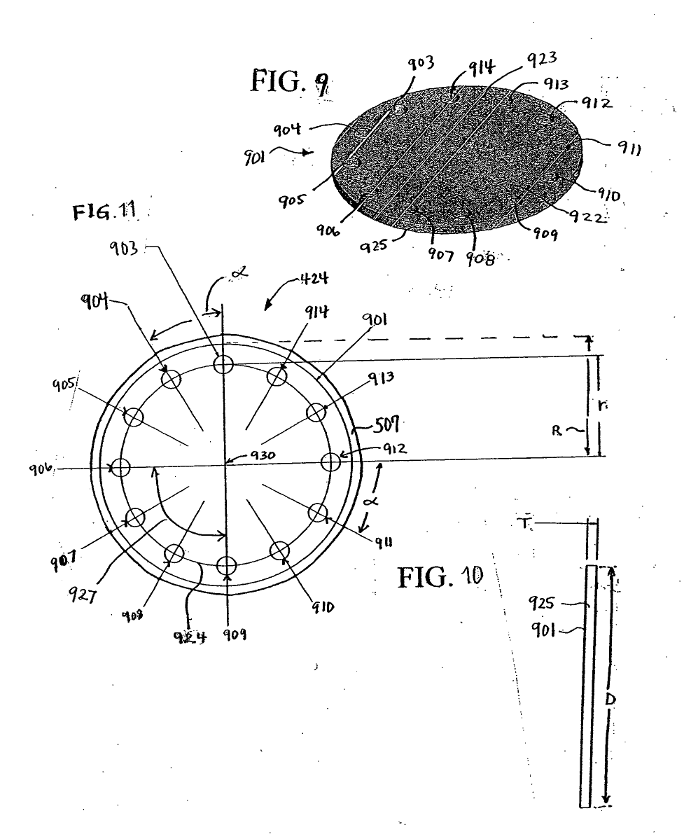

In a preferred embodiment of the invention, the dosing head 106 including nozzle 425 discharges liquid nitrogen from a plurality of nozzle orifices arranged in a substantially circular profile. To accomplish this, the nozzle 425 is an integral assembly comprising nozzle body 501 having a flanged end 507 (FIG. 5), which is adapted to receive an orifice plate 901 (FIG. 9) from which liquid nitrogen is discharged from the nozzle 425 into an open mouth of a bottle or container.

Additional details and arrangements regarding the liquid nitrogen reservoir 102, flexible conduit 104, sensor 108, supply conduit 110, cylinders 112 and 114, post 116, control unit 120, dosing head control valve 411, purge system, and other components and features of system 100 which may be useful in conjunction with the invention are described, for example, in U.S. Pat. No. 6,182,715 B1, which descriptions are incorporated herein by reference.

As shown in more detail in FIG. 5, the nozzle body 501 includes an externally threaded stem 503 having an internal passageway 509 that opens into a skirt 505. The skirt 505 has a flanged end 507. As can be seen in FIG. 6, the flanged end 507 has a depth “t”. In FIG. 7, the central location of passageway 509 is seen, which is used to feed a stream of liquid nitrogen inside skirt 505. In FIG. 8, the skirt 505 defines an interior space 511. The flanged end 507 includes a ledge 513, and defines a recess 508 having a diameter “w” and thickness “t”.

Referring to FIG. 9, in this embodiment the orifice plate 901 has a three-dimensional disc shape which substantially conformably fits within recess 508 of nozzle body 501. As shown, the orifice plate 901 has a plurality of through-holes or apertures 903 through 914 extending from one major face 923 of the disc-shaped member to the opposite face, which are surrounded by the solid portion 922 of orifice plate 901.

FIG. 10 is an edge view of orifice plate 901 showing the thickness “T” of the side edge 925 and diameter “D” of the plate. The thickness “T” of orifice plate 901 is selected to be equal to or just slightly less than the above-noted thickness “t” of the flanged end 507 of the nozzle body 501, and a diameter “D” is a value equal to or just slightly less the diameter “w” of the flanged end 507 of the nozzle body 501, such that orifice plate 901 can be snugly positioned within recess 508 of the flanged end 507 of nozzle body 501. In one embodiment, the nozzle body 501 and orifice plate 901 are both metal construction, and the orifice plate is fixed in position, preferably flush within recess 508 of nozzle body 501, by soldering, welding, mechanical engagement, and/or other methods of attachment.

Referring to FIG. 11, in this embodiment the plurality of apertures 903-914, of orifice plate 901 are provided in a substantially circular pattern or layout 924. In operation, liquid nitrogen is simultaneously discharged from the nozzle 425 via apertures 903 through 914 of orifice plate 901 during pressurization or inerting operations performed on filled bottles or other containers. In a preferred embodiment, the configuration of apertures provided in the nozzle orifice plate is designed to provide a dose of liquid cryogen into a container as a generally ring-shaped “shower” of discrete liquid cryogen streams which can be gently impacted with the surface of the fluid contents to minimize splashing.

In this illustration, the plurality of apertures 903 to 914 are substantially equidistantly spaced from adjoining apertures by an angle alpha (α). In one non-limiting embodiment, the separation angle alpha (α) between adjacent apertures arranged in a substantially circular layout 924 in an orifice plate 901 as described herein is about 25° to about 35°, preferably between about 28° to about 32°. In one embodiment, at least two apertures, and preferably at least three apertures, are present in each 90° quadrant 927 of plate 901. In a preferred embodiment, no additional apertures are located radially inside the circular pattern 924 of apertures.

In one non-limiting embodiment, the apertures 903 to 914 are each located a radial distance “r” from the geometric center 930 of the orifice plate 901, which is about 60% to about 95%, and particularly about 75% to about 90%, of the overall radius “R” of the orifice plate 901. In one preferred embodiment, no aperture is present in the orifice plate 901 at a radial distance “r” within 60% of the distance of disc radius “R.”

In one embodiment, for liquid nitrogen delivery systems operating at about 0.9 to about 1.1 psia internal nozzle pressure, a shower of liquid nitrogen streams may be dispensed using the above-noted pattern of orifice plate apertures 903 to 914 with aperture (hole) diameters ranging from about 0.75 to about 1.0 mm, particularly about 0.80 to about 0.95 mm, and the thickness of “T” of plate 901 may be from about 0.4 to about 0.6 mm. These parameters are meant to be exemplary and not limiting of conditions which may provide the desired spray characteristics and performance, as discussed in more detail below.

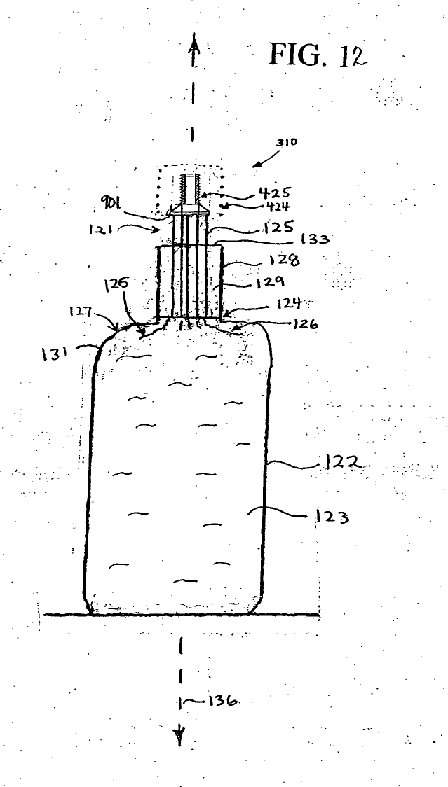

Referring to FIG. 12, the orifice plate 901 provided in nozzle 425 includes a layout or pattern of apertures effective to deliver liquid nitrogen into a hot-filled, upright open (unsealed) bottle 122. After receiving a dose of liquid nitrogen, the container is transported to a capping station (not shown), which may be a conventional design for that purpose, soon thereafter for a sealing operation.

The hot-filled bottle 122 includes a heated fluid 123 filled up to a surface level 124 located just above the shoulder 127 of the bottle 122. A small headspace 129 exists between the fluid surface 124 and the top of the throat 128 of the bottle 122. In this non-limiting illustration, a total dose of liquid nitrogen is added inside container 122 to generate enough pressure to counteract the vacuum and subsequent paneling effects that may be created when a hot product cools in a sealed container.

In accordance with a preferred embodiment of this invention, liquid nitrogen is dispensed from orifice plate 901 of nozzle 425 as a shower 121 comprised of a plurality of relatively soft, gentle streams 125. These relatively soft, gentle streams 125 of liquid nitrogen impact and penetrate the liquid content surface 124 lightly without causing splashing of liquid nitrogen or bottle contents back out of the bottle. The streams 125 of liquid nitrogen may be dispensed continuously or pulsed via appropriate system pressure regulation and valving control. Each stream preferably comprises a substantially steady current or flow of liquid cryogen, and not an atomized spray thereof, during a discrete dosing or continuous dosing of the fluid contents of a container.

In one embodiment, the pattern of impacts made by dispensed liquid nitrogen streams 125 at the liquid content surface level 124 within the bottle 122 is substantially similar to the stream discharge pattern 924 on the overlying orifice plate 901 of the nozzle 425. It will be appreciated that the radius “r” dimension selected for apertures 903 to 914 should be less than the inner diameter of the container opening 133 through which the streams of liquid nitrogen will be introduced. It is desirable to spread out and isolate the individual stream impact sites as much as possible. At a minimum, the radius “r” dimension parameter must be great enough to avoid dropping stream volumes in a concentrated central area of surface level 124 to the extent the combined effect leads to splashing of contents back out of the container.

Although not desiring to be bound to any theory, the above-noted shower head design of orifice plate 901 is thought to encourage a fluid dynamic phenomenon in which the streams 125 of liquid nitrogen dispensed into the open mouth 133 of bottle 122 as shower 121 tend to push or move radially outward towards the walls 131 of the bottle 122, instead of pushing relatively straight down (vertically) a significant depth into the fluid 123. The result is that an insignificant amount of splashing, if any, occurs.

By comparison, if a standard single port injection nozzle arrangement is used, liquid nitrogen is observed to inject relatively deeply into the fluid content of a hot filled container (e.g., up to several inches depth), whereupon a highly physically agitated fluid combination results, which may resemble intense “boiling.” The resulting highly agitated fluid produces droplets of liquid nitrogen, and or fluid content, that rapidly splashes back out of the container.

Avoidance of such splashing is crucial. Any splashed-out liquid nitrogen is lost from the container, and thus is not available to pressurize the container during subsequent processing and handling. A filled container lacking a sufficient dose of liquid nitrogen for pressurization is prone to misshape during subsequent exposure to structural stress such as may be encountered during bottle (or can) capping procedures, and or during stacking or other handling exerting structural pressure on the capped containers.

The precise, non-splashing liquid cryogen dosing achieved using the nozzle of an embodiment of the invention significantly eliminates “duds” and rework otherwise that may be associated with misshapen hot filled containers in particular. In particular, liquid cryogen pressurization implemented using the inventive nozzle arrangement prevents paneling of containers in hot-fill applications.

A dose of liquid nitrogen or other suitable cryogen added via the nozzle arrangement of an embodiment of this invention adds enough pressure to counteract the vacuum and subsequent paneling effects created when a hot product cools in a sealed container. The reduced nitrogen splashing achieved provides more reliable container strengthening, and may allow for use of lower gram weight bottles or cans, in addition to reducing waste associated with overfilling of containers. It thus provides a more efficient and cost effective packaging solution.

Also, avoidance of splashing also helps to prevent clogging of the nozzle from freeze-up of splashed nitrogen back into the nozzle area. Use of standard electric heater arrangements alone in nozzles has been observed to be insufficient to prevent such freeze-up under some typical operating conditions.

Referring again to FIG. 12, as another advantage, and unlike prior liquid cryogen delivery systems used for pressurizing containers, the nozzle 425 of an embodiment of the invention need not be inclined relative to the longitudinal axis 136 of the filled container 122 to minimize or prevent splash back and associated freeze-ups of the nozzle. For example, the nozzle 425 may be oriented to dispense liquid nitrogen streams 125 having trajectories substantially parallel, e.g., within about 0 to about 5 degrees inclination, relative to the longitudinal axis 136 of bottle 122. Bottles having narrowed throats preferably have the liquid nitrogen dispensed therein from essentially directly above, and not from an angle. Containers having wider mouths, such as cans, may be permit some inclination angle of the nozzle, although direct overhead dispensing is still preferred in most instances in the practice of the invention.

The nozzle arrangement in accordance with an embodiment of this invention may be used in liquid nitrogen dosing operations performed on high-speed production lines, such as accommodating lines speeds ranging from about 400 to about 2000 dosed containers per minute, in a pulsed (discrete) dosing mode of operation of the nozzle. In one embodiment, line speeds of about 600 containers or more per minute are handled. If a continuous stream dosing mode of nozzle operation is used, these and even greater line speeds may be accommodated.

Liquid nitrogen doses may be set anywhere from about 0.01 g per second to about 20 g per second, and the dose will depend on the amount needed for strengthening the particular container and contents filled thereof. In one embodiment, the liquid nitrogen nozzle arrangement may be used in liquid nitrogen delivery systems for dispensing substantially uniformly about 0.8 to about 1.0 g liquid nitrogen per container in a high speed production line running at a rate exceeding about 500 containers or more per minute. The liquid nitrogen nozzle arrangement in accordance with an embodiment herein allows high dosing accuracy to be maintained, such as ±5% of a target dose value per container, even in high speed production lines.

A liquid nitrogen dosing head including a nozzle in accordance with an embodiment of the invention may be used generally in liquid cryogen dosing systems used for pressurization and or product inerting. The nozzle arrangement described herein is generally effective for pressurizing or inerting operations performed with relatively thin-walled packaging containers used for ambient or hot filling applications. These thin-walled product containers include, for example, thin-walled metal (e.g., aluminum), glass, and plastic (e.g., polyethylene terephthalate (PET)) containers. The containers may be in the form of a bottle, can, or another container type. For instance, the nozzle arrangement in accordance with an embodiment of this invention is useful for pressurizing hot-filled aluminum “bottle can” type beverage containers.

The hot-filled non-carbonated food products that may be successfully packaged in thin-walled containers which are pressurized with liquid nitrogen using the nozzle arrangement of an embodiment of the invention are not particularly limited, and includes hot filled beverages such as fruit drinks or teas; tomato sauce, edible oils, dessert syrups, coffee concentrates, and so forth. In one embodiment, a “hot filled” product, as referenced herein, refers to a comestible product heated to a temperature of approximately 60° C. to 96° C. that is placed in a container, which then is subjected to liquid nitrogen introduction before sealing the container.

The nozzle arrangement of the invention also may be used for cryogen inerting of non-carbonated food products and beverages, such as, for example, wine, to reduce oxygen levels thereof.

A commercially-available liquid nitrogen delivery system which may be adapted to use a shower head type nozzle according to an embodiment of the invention includes, for example, the LCI-2000M liquid cryogen delivery system manufactured by VBS Industries, Inc., Campbell, Calif., U.S.A. For instance, the external threading provided on the nozzle body of a nozzle in accordance with an embodiment of the invention may be designed to match to female threading provided for detachable mounting of a single port nozzle on commercial dosing heads, such as the LCI-2000M liquid cryogen delivery system. The threaded or other detachable mount for a nozzle often is provided to facilitate nozzle changes or equipment maintenance.

Commercial liquid cryogen dosing systems, such as the above-noted LCI-2000M system and the like, are available which generally include an operator interface supporting data monitoring, data display, data entry, recipe download, and PLC speed compensation. For example, the computer control interface on the above-noted LCI-2000M system allows an operator to adjust dose values and compensate for changes in line speed or container shapes, or other production line variations.

The timing of dosing on the above-noted LCI-2000M system may be controlled by standard means such as container detector means. For example, as noted, a sensor may be used to detect the presence of a container, and then the controller may initiate a solenoid and a pneumatic-actuated or otherwise actuated dosing valve may be used to dispense a dose of liquid cryogen from the nozzle mounted in the dosing head. A programmable change over point may be provided from discrete (pulsed) dosing to steady stream dosing.

The LCI-2000M liquid cryogen delivery system also includes a vacuum insulated liquid nitrogen reservoir which provides constant liquid pressure at the dosing head. A typical flow (consumption) rate of LN2 in the LCI-2000M liquid cryogen delivery system equipped with an nozzle arrangement of an embodiment of this invention generally may be about 3.5 to about 4.5 cubic feet per hour. The presence of an internal, self-generated gaseous cryogen purge feature along with self-regulating heaters in such a commercial liquid cryogen delivery system further helps to assure moisture intrusion and ice/frost accumulation is prevented from obstructing or clogging the dosing head nozzle. The nozzle configuration described herein accommodates, if optionally desired or needed, a slim profile dosing head including the above-noted nozzle, as used together with a flexible dosing arm, which allows for easier integration into lines with minimal space availability.

The use of nozzle design in accordance with an embodiment of the invention in a LCI-2000M liquid cryogen delivery system in lieu of a standard single port nitrogen dosing nozzle has been observed to significantly reduce product container anomalies at least approximately 85%, or even more, for hot-filled juice products bottled in 16.5 ounce aluminum “bottle cans”, which were dosed with liquid nitrogen immediately before capping. The inventive nozzle design allows for better control of internal container pressures and allows the factory to operate within a more consistent level of pressure that can be obtained using conventional nitrogen dosing nozzles.

For instance, in one embodiment, relatively uniform and consistent internal pressures ranging from approximately 14 to 20 psia may be provided within containers dosed with liquid nitrogen using a nozzle arrangement in accordance with an embodiment of the invention. These internal pressures are generally adequate for strengthening the container before typical capping and handling. By comparison, internal pressures vary much more widely in similar containers filled with conventional single port liquid nitrogen nozzle arrangements.

Although illustrations herein may refer to liquid nitrogen as the exemplified cryogen used, it will be appreciated that other liquefiable cryogens, such as liquefied argon gas, liquefied carbon dioxide, or mixtures thereof, also may be used, to the extent they have a suitable volatility and inertness to the material stored in the container being pressurized or inerted.

While the invention has been particularly described with specific reference to particular process and product embodiments, it will be appreciated that various alterations, modifications and adaptations may be based on the present disclosure, and are intended to be within the spirit and scope of the invention as defined by the following claims.

What is claimed is:

1. A liquid cryogen dosing head for introducing a dose of liquid cryogen into a product moving along a packaging assembly line, comprising:
a control valve operable to receive a flow of liquid cryogen from a liquid cryogen supply reservoir and controllably output metered doses of liquid cryogen to a dispensing nozzle in fluid communication therewith; and
a nozzle, in fluid communication with the control valve, adapted to dispense liquid cryogen as a plurality of simultaneously flowing liquid streams, wherein the nozzle comprises a nozzle body having a passageway which fluidly communicates with an orifice plate having a plurality of apertures through which the streams are dispensed.

2. The liquid cryogen dosing head of claim 1, wherein the orifice plate comprises a disc shape.

3. The liquid cryogen dosing head of claim 1, wherein the plurality of apertures are arranged in a substantially circular pattern in the orifice plate.

4. The liquid cryogen dosing head of claim 1, The liquid cryogen dosing head of claim 1, wherein the apertures are located a radial distance from a geometric center of the orifice plate of about 60% to about 95% of an overall radius of the orifice plate.

5. The liquid cryogen dosing head of claim 1, wherein the apertures are located a radial distance from a geometric center of the orifice plate of about 75% to about 90% of an overall radius of the orifice plate.

6. The liquid cryogen dosing head of claim 1, wherein all apertures in the orifice plate are located a radial distance of at least about 60% of an overall radius of the orifice plate.

7. The liquid cryogen dosing head of claim 1, wherein the apertures have a separation angle between adjacent apertures comprising about 25° to about 35°.

8. The liquid cryogen dosing head of claim 1, wherein the apertures have a separation angle between adjacent apertures comprising about 28° to about 32°.

9. The liquid cryogen dosing head of claim 2, wherein at least two of the apertures are present in each 90° quadrant of the orifice plate.

10. The liquid cryogen dosing head of claim 2, wherein at least three of the apertures are present in each 90° quadrant of the orifice plate.

11. The liquid cryogen dosing head of claim 2, wherein the nozzle is adapted to dispense liquid nitrogen simultaneously as the plurality of liquid streams thereof.

12. A system for introducing a dose of liquid cryogen into a container on a production line before sealing, comprising:
a liquid cryogen supply reservoir; and
a dosing head mounted above a moving production packaging assembly line, and comprising:
a control valve operable to receive a flow of liquid cryogen from the liquid cryogen supply reservoir and controllably output metered doses of liquid cryogen to a dispensing nozzle in fluid communication therewith, and
a nozzle, in fluid communication with the control valve, adapted to dispense liquid cryogen as a plurality of simultaneously flowing liquid streams into an open container on the moving production packaging assembly line, wherein the nozzle comprises a nozzle body having a passageway which fluidly communicates with an orifice plate having a plurality of apertures through which the streams are dispensed.

13. The system of claim 12, wherein the orifice plate comprises a disc shape.

14. The system of claim 12, wherein the plurality of apertures are arranged in a substantially circular pattern in the orifice plate.

15. The system claim 12, wherein the apertures are located a radial distance from a geometric center of the orifice plate of about 60% to about 95% of an overall radius of the orifice plate.

16. The system of claim 12, wherein the apertures have a separation angle between adjacent apertures comprising about 25° to about 35°.

17. The system of claim 12, wherein at least two of the apertures are present in each 90° quadrant of the orifice plate.

18. The system of claim 12, wherein the liquid cryogen reservoir contains liquid nitrogen.

19. A method for pressurizing or inerting a hot filled product, comprising;
providing a open container hot filled with fluid contents;
moving the hot-filled container beneath a liquid cryogen dosing head, wherein the dosing head comprises:
a control valve operable to receive a flow of liquid cryogen from a liquid cryogen supply reservoir and controllably output metered doses of liquid cryogen to a dispensing nozzle in fluid communication therewith, and
a nozzle comprising a nozzle body and an orifice plate, wherein the nozzle body has a passageway which fluidly communicates with the control valve at an inlet thereof and with the orifice plate at an outlet thereof, wherein the orifice plate has a plurality of apertures; and
dispensing liquid cryogen from the orifice plate of the nozzle into the container as a plurality of simultaneously flowing liquid streams.

20. The method of claim 19, wherein the providing of the container comprises conveying the container on a moving production packaging assembly line beneath the dosing head, and after receiving a dose of liquid cryogen, then to a sealing station.

21. The method of claim 19, wherein the moving production packaging assembly line conveys between about 400 to about 2000 containers per minute beneath the dosing head for receipt of a dose of liquid cryogen.

22. The method of claim 21, wherein each container receives about 0.8 to about 1.0 g liquid nitrogen per container.

23. The method of claim 19, wherein dispensing comprising providing about 0.9 to about 1.1 psia internal nozzle pressure.

24. The method of claim 19, wherein the fluid contents comprise a substantially non-carbonated comestible product a temperature of approximately 60° C. to 96° C.

25. The method of claim 19, wherein the container comprises a thin-walled product container.

26. The method of claim 19, wherein the container is selected from the group consisting of a bottle, a can, or a combination thereof.

27. The method of claim 26, wherein the container comprises plastic, metal, or glass material.

28. The method of claim 19, wherein the fluid contents comprise a beverage or foodstuff selected from the group consisting of a fruit drink, a tea, a coffee concentrate, a soup, a sauce, an edible oil, and a dessert syrup.
